(19) United States
(12) Patent Application Publication
(10) Pub. No.: US 2025/0314851 A1
(43) Pub. Date: Oct. 9, 2025

(54) VIBRATION TYPE ACTUATOR, LENS BARREL, IMAGE CAPTURING APPARATUS, AND STAGE APPARATUS

(71) Applicant: CANON KABUSHIKI KAISHA, Tokyo (JP)

(72) Inventor: KEI SUEFUJI, Tokyo (JP)

(21) Appl. No.: 19/243,242

(22) Filed: Jun. 19, 2025

Related U.S. Application Data
(63) Continuation of application No. PCT/JP2023/044220, filed on Dec. 11, 2023.

(30) Foreign Application Priority Data
Dec. 23, 2022 (JP) 2022-206675

(51) Int. Cl. G02B 7/105; G02B 21/24; G03B 5/00

(52) U.S. Cl. CPC G02B 7/105; G02B 21/241; G03B 5/00; G03B 2205/0007; G03B 2205/0061

(57) ABSTRACT

In a vibration type actuator according to the present invention, a lower support member includes a pair of guide portions that guide a relative position of a holding member and the lower support member in a second direction, and the holding member includes a pair of guide receiving portions that are guided by the pair of guide portions. An encoder main body is fixed to the lower support member at a position overlapping with an area sandwiched between the pair of guide receiving portions as viewed from the second direction.

### CROSS-REFERENCE TO RELATED APPLICATIONS

This application is a Continuation of International Patent Application No. PCT/JP2023/044220, filed Dec. 11, 2023, which claims the benefit of Japanese Patent Application No. 2022-206675, filed Dec. 23, 2022, both of which are hereby incorporated by reference herein in their entirety.

### BACKGROUND OF THE INVENTION

### Field of the Invention

The present invention relates to a vibration type actuator, a lens barrel, an image capturing apparatus, and a stage apparatus.

### Background Art

In general, a vibration type actuator obtains a driving force by bringing a vibrating body and a driven body into pressure contact and frictionally driving the vibrating body and the driven body relative to each other using vibration excited in the vibrating body.

A vibration type actuator has a simple and thin structure and can be driven quietly with high accuracy and thus is used as a driving motor for a turning driving device of a lens barrel, a camera platform, and the like, a factory automation (FA) production apparatus, an office automation (OA) device, and the like.

According to PTL 1, a vibration type actuator is discussed that has a structure in which a contact body is sandwiched between two vibrating bodies in its thickness direction (a direction orthogonal to a longitudinal direction and a transverse direction of the contact body) and the vibrating bodies are driven in the longitudinal direction of the contact body along a guide bar.

### CITATION LIST

### Patent Literature

PTL 1: Japanese Patent Application Laid-Open No. 2021-87317

A vibration type actuator may be provided with an encoder main body and a scale in order to perform positioning with high accuracy. However, the vibration type actuator according to PTL 1 may not be able to detect a relative movement between the vibrating body and the contact body with high accuracy depending on positions to which an encoder main body and a scale are attached. In other words, if any backlash or the like occurs between the vibrating body and a component to which the encoder main body is attached, the backlash causes the encoder main body to move relative to the scale. Thus, even though the vibrating body is not moved relative to the contact body, a signal indicating the movement is detected from the encoder, which may cause driving of the vibration type actuator to be unstable, deteriorating positioning accuracy thereby.

### SUMMARY OF THE INVENTION

The present invention is directed to driving a vibration type actuator with high accuracy.

According to an aspect of the present invention, a vibration type actuator including a vibrating body that includes an electrical-mechanical energy conversion element and a protrusion portion, and a contact body with which the protrusion portion is in contact and that is provided to be movable relative to the vibrating body in a first direction, incudes a holding unit configured to apply pressure to the vibrating body toward the contact body in a second direction that intersects with the first direction and to hold the vibrating body to be able to vibrate, a support unit configured to support the vibrating body via the holding unit, and a position detection unit that is fixed to the support unit and configured to detect a position of the vibrating body or the contact body, wherein either one of the holding unit and the support unit includes a pair of guide portions that guide a relative position of the holding unit and the support unit in the second direction, wherein the other one of the holding unit and the support unit includes a pair of guide receiving portions that are guided by the pair of guide portions, and wherein the position detection unit is fixed to the support unit at a position overlapping with an area sandwiched between the pair of guide receiving portions as viewed from the second direction.

Further features of the present invention will become apparent from the following description of exemplary embodiments with reference to the attached drawings.

### BRIEF DESCRIPTION OF THE DRAWINGS

FIG. 1 is a perspective view illustrating a schematic configuration of a vibration type actuator according to a first exemplary embodiment.

FIG. 2 is an exploded perspective view of the vibration type actuator.

FIG. 3A is an exploded perspective view of a lower support member of the vibration type actuator.

FIG. 3B is an exploded perspective view of the lower support member of the vibration type actuator.

FIG. 4A is a perspective view illustrating a natural vibration mode to be excited in a vibrating body.

FIG. 4B is a perspective view illustrating a natural vibration mode to be excited in the vibrating body.

FIG. 5A illustrates a configuration of the lower support member of the vibration type actuator.

FIG. 5B illustrates a configuration of the lower support member of the vibration type actuator.

FIG. 6A illustrates a configuration of an encoder main body.

FIG. 6B illustrates a configuration of the encoder main body.

FIG. 7A illustrates a configuration of the lower support member of the vibration type actuator.

FIG. 7B illustrates a configuration of the lower support member of the vibration type actuator.

FIG. 8A illustrates a configuration of a lower support member of a vibration type actuator according to a comparative example.

FIG. 8B illustrates a configuration of the lower support member of the vibration type actuator according to the comparative example.

FIG. 9A illustrates a configuration of a vibration type actuator according to a second exemplary embodiment.

FIG. 9B illustrates a configuration of the vibration type actuator according to the second exemplary embodiment.

FIG. 9C illustrates a configuration of the vibration type actuator according to the second exemplary embodiment.

FIG. 10 is a top view illustrating a schematic configuration of an image capturing apparatus according to a third exemplary embodiment.

FIG. 11 is a perspective view illustrating a schematic configuration of a microscope according to a fourth exemplary embodiment.

### DESCRIPTION OF THE EMBODIMENTS

Exemplary embodiments of the present invention will be described below with reference to the attached drawings.

### First Exemplary Embodiment

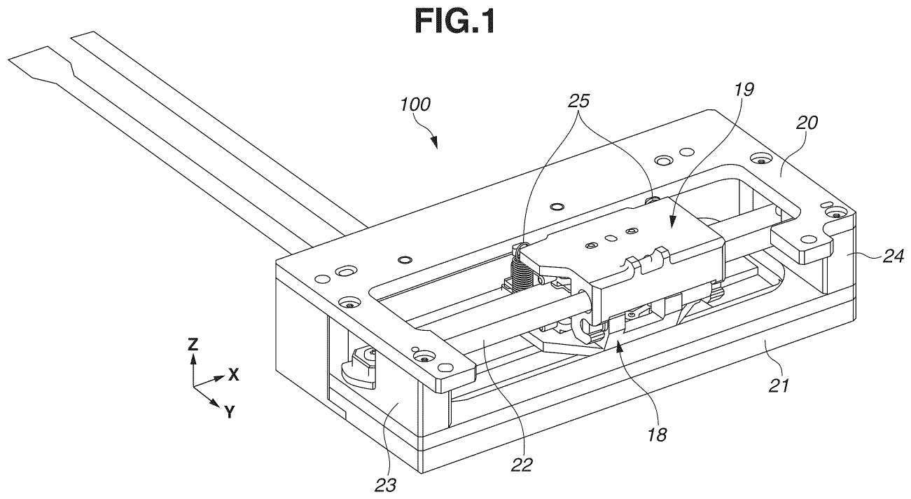

FIG. 1 is a perspective view illustrating a schematic configuration of a vibration type actuator 100 according to a first exemplary embodiment.

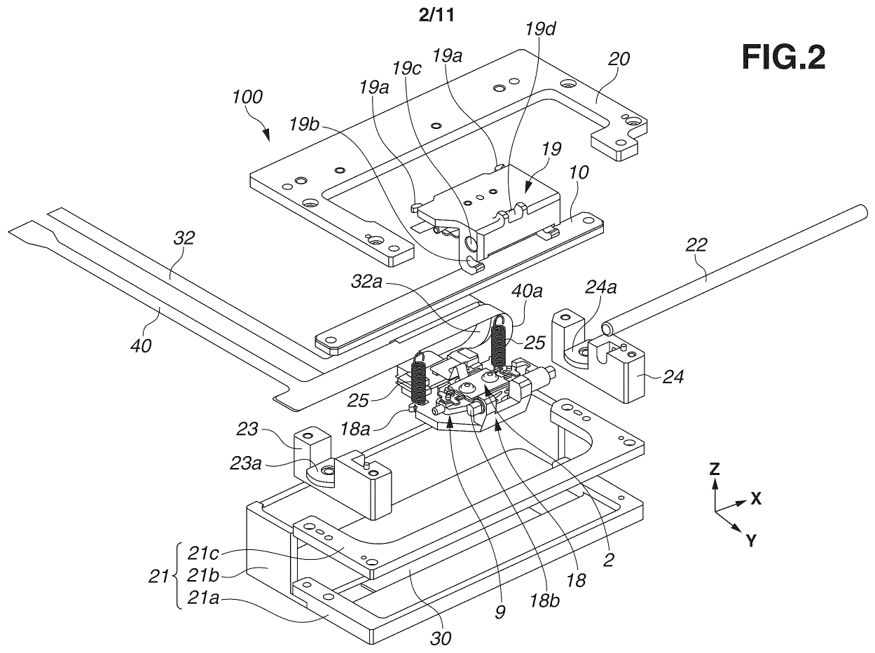

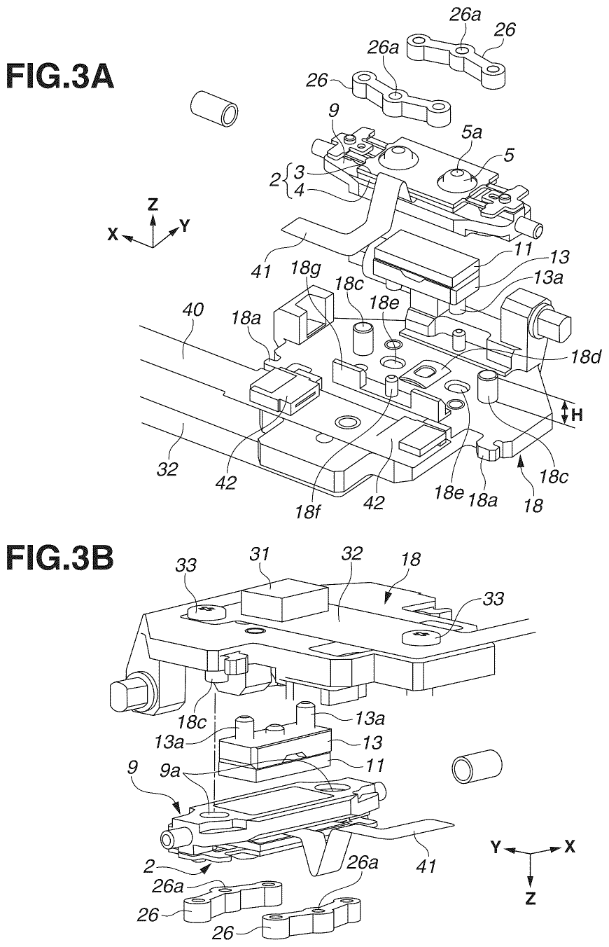

FIG. 2 is an exploded perspective view of the vibration type actuator 100. FIGS. 3A and 3B are exploded perspective views of a lower support member 18. FIG. 3A is the exploded perspective view of the lower support member 18 as viewed from above, and FIG. 3B is the exploded perspective view of the lower support member 18 as viewed from below.

The vibration type actuator 100 includes a vibrating body 2, a holding member 9, a contact body 10, the lower support member 18, an upper support member 19, a top plate 20, a foundation unit 21, a guide bar 22, contact body holding units 23 and 24, and a tension coil spring 25.

The vibrating body 2 includes an elastic body 3, a pair of protrusion portions 5 provided on one surface of the elastic body 3, and a piezoelectric element 4 provided on a surface of the elastic body 3 opposite to the surface on which the protrusion portions 5 are provided (see FIGS. 3A and 3B). The protrusion portions 5 are not limited to a pair, and the contact body 10 can be driven with at least one protrusion portion 5.

The elastic body 3 is substantially rectangular and has a flat plate shape. The elastic body 3 is made of a metallic material such as martensitic stainless steel and is subjected to a quenching treatment as a hardening treatment to improve durability.

The protrusion portion 5 is a portion that protrudes from one surface of the elastic body 3 toward the contact body 10. The protrusion portion 5 is formed with a thickness having a spring characteristic. The protrusion portion 5 is integrally formed with the elastic body 3, for example, by press working on a sheet material that forms the elastic body 3. However, the protrusion portion 5 is not limited to being integral with the elastic body 3 and may be fixed to the elastic body 3 by welding, for example. A tip end 5a (upper surface) of the protrusion portion 5 is subjected to a hardening treatment such as a quenching treatment to improve wear resistance since the tip end 5a is subjected to frictional sliding with the contact body 10.

The holding member 9 (holding unit) holds the vibrating body 2 from a side opposite to the surface on which the protrusion portion 5 is provided so that the vibrating body 2 can vibrate. The holding member 9 is urged by the tension coil spring 25 to press the vibrating body 2 toward the contact body 10.

The contact body 10 can move relative to the vibrating body 2. The contact body 10 is made of a metallic material such as stainless steel, and a frictional sliding surface with the protrusion portion 5 is subjected to a hardening treatment such as a nitriding treatment in order to improve wear resistance.

The piezoelectric element 4 is an electrical-mechanical energy conversion element that converts an electrical quantity into a mechanical quantity. The piezoelectric element 4 is bonded to the elastic body 3 by an adhesive. The piezoelectric element 4 has a structure in which electrodes having a predetermined shape are formed on both surfaces of a plate-shaped piezoelectric ceramic. A driving voltage (alternating current voltage) with a predetermined frequency is applied to the electrodes of the piezoelectric element 4 from a power supply flexible substrate 41. In response to the application of the driving voltage, the piezoelectric element 4 excites the vibrating body 2 to vibrate in a first vibration mode and a second vibration mode, which are described below, and causes two protrusion portions 5 to perform an elliptical motion in a plane that includes a direction connecting the two protrusion portions 5 and a protruding direction of the protrusion portions 5. Thus, the protrusion portions 5 frictionally drive (hereinbelow referred to as driving) the contact body 10 and can linearly drive the contact body 10 and the vibrating body 2 relative to each other.

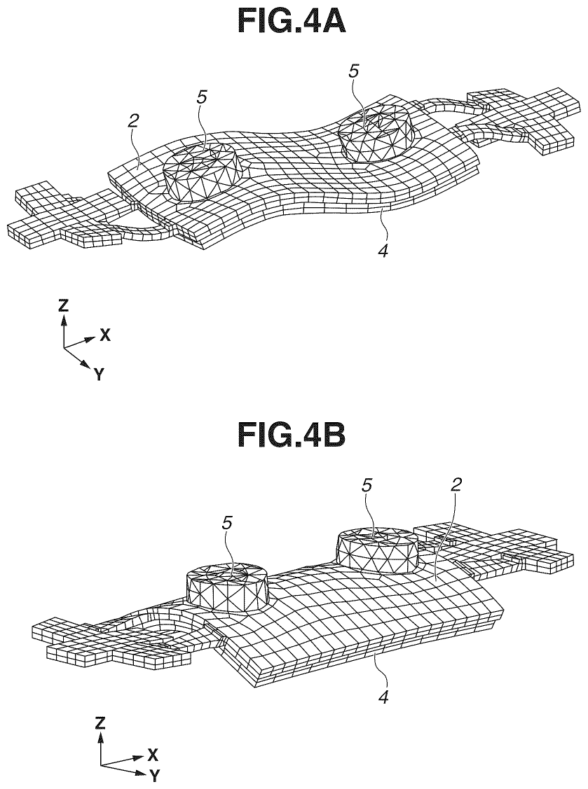

FIGS. 4A and 4B are perspective views illustrating natural vibration modes to be excited in the vibrating body 2 in order to drive the vibration type actuator 100 (to relatively move the vibrating body 2 and the contact body 10). FIG. 4A is the perspective view illustrating the first vibration mode excited in the vibrating body 2 to drive the vibration type actuator 100. FIG. 4B is the perspective view illustrating the second vibration mode excited in the vibrating body 2 to drive the vibration type actuator 100.

FIGS. 4A and 4B illustrate displacement amounts enlarged compared to a shape of the vibrating body 2 in order to facilitate understanding of a deformed shape. Further, an X direction, a Y direction, and a Z direction are indicated to describe the first vibration mode and the second vibration mode. The X direction is a direction connecting the two protrusion portions 5 (the tip ends thereof) and is also a longitudinal direction of the vibrating body 2. The Z direction is the protruding direction of the protrusion portion 5 and is also a direction in which the vibrating body 2 is pressed and comes into contact with the contact body 10. The Y direction is a direction orthogonal to (intersecting) the X direction and the Z direction and is also a transverse direction of the vibrating body 2.

The first vibration mode is a mode that generates a secondary (two vibration antinodes) bending vibration in the X direction (the longitudinal direction of the vibrating body 2) and has three vibration nodes (hereinbelow, referred to as nodes) parallel to the Y direction. The protrusion portion 5 (the tip end thereof) reciprocates in the X direction due to the vibration in the first vibration mode. At this time, the protrusion portion 5 is arranged at or near a position that becomes a node in the vibration in the first vibration mode (so as to overlap with the position that becomes the node in the vibration in the first vibration mode), so that it is possible to maximize an amount of displacement of the protrusion portion 5 (the tip end thereof) in the X direction.

The second vibration mode is a mode that generates a primary (one vibration antinode) bending vibration in the Y direction (the transverse direction of the vibrating body 2) and has two nodes parallel to the X direction. The protrusion portion 5 reciprocates in the Z direction due to the vibration in the second vibration mode. At this time, the protrusion portion 5 is arranged at or near a position that becomes an antinode in the second vibration mode (so as to overlap with the position that becomes the antinode in the vibration in the second vibration mode), so that it is possible to maximize an amount of displacement of the protrusion portion 5 in the Z direction.

The vibrating body 2 can generate an elliptical motion at the tip end of the protrusion portion 5 in substantially a ZX plane by combining the first vibration mode and the second vibration mode, and the elliptical motion generates a driving force for driving the vibrating body 2 in substantially the X direction. At this time, each of the two protrusion portions 5 is arranged at or near the node position of the first vibration mode and the antinode position of the second vibration mode, so that vibration displacements of the protrusion portions 5 (the tip ends thereof) can be maximized, and high output can be acquired.

Returning to FIGS. 1, 2, 3A, and 3B, the vibration type actuator 100 is described.

The vibration type actuator 100 has a configuration in which the contact body 10 is sandwiched between the vibrating body 2 supported by the lower support member 18 (support unit) and the vibrating body 2 supported by the upper support member 19 (support unit). End portions of the contact body 10 in the longitudinal direction are respectively fixed to the contact body holding units 23 and 24 via damping rubber 23a and 24a. The damping rubber 23a and 24a are made of butyl rubber, silicone rubber, or the like, which has high vibration damping performance. The damping rubber 23a and 24a suppress generation of an unnecessary vibration in the contact body 10 while the vibration type actuator 100 is driven. Thus, generation of abnormal noise is suppressed, and a decrease in output is prevented in the vibration type actuator 100.

The foundation unit 21 includes a scale holding unit 21a, an outer frame unit 21b, and a bottom plate 21c. A scale 30 is fixed to the scale holding unit 21a with an adhesive, an adhesive tape, or the like to be substantially parallel to the contact body 10 in the X direction. The contact body holding units 23 and 24, the top plate 20, and the foundation unit 21 are connected by screws or the like to form a base of the vibration type actuator 100.

The guide bar 22 guides the upper support member 19. The guide bar 22 is arranged to be substantially parallel to the contact body 10 in the X direction. End portions of the guide bar 22 in an axial direction are respectively fixed to the contact body holding units 23 and 24.

The upper support member 19 is provided with a through hole portion 19c into which the guide bar 22 is slidably fitted (see FIG. 2). The guide bar 22 is fitted into the through hole portion 19c, so that the upper support member 19 is guided in the axial direction (the X direction) of the guide bar 22 serving as a guide member and can move relative to the contact body 10. The upper support member 19 is provided with a spherical drive transmission unit 19d at its upper portion. The drive transmission unit 19d and a driven object are connected, so that a driving force of the vibration type actuator 100 is transmitted to the driven object. Grease may be applied to smoothen sliding between the through hole portion 19c of the upper support member 19 and the guide bar 22.

The lower support member 18 is provided with a connecting pin 18b protruding in the X direction. The connecting pin 18b is connected to a connection receiving portion 19b provided on the upper support member 19, so that the lower support member 18 is positioned with respect to the upper support member 19. Thus, the lower support member 18 and the upper support member 19 are guided along the guide bar 22 and can move integrally.

The tension coil spring 25 is suspended between a spring receiving portion 18a provided on the lower support member 18 and a spring receiving portion 19a provided on the upper support member 19. The tension coil spring 25 urges the lower support member 18 and the upper support member 19 in a direction in which they draw each other. Thus, the tip end 5a of the protrusion portion 5 of the vibrating body 2 supported by each of the lower support member 18 and the upper support member 19 is held in a state of being in pressure contact with the contact body 10. A means for urging the lower support member 18 and the upper support member 19 in the direction in which they draw each other is not limited to the tension coil spring 25 and may be a conical coil spring, rubber, or the like.

The vibrating body 2 supported by each of the lower support member 18 and the upper support member 19 is connected to the power supply flexible substrate 41. The power supply flexible substrate 41 is connected by being inserted into a connection connector 42 of a connecting flexible substrate 40. The connecting flexible substrate 40 applies an alternating current signal such that elliptical motions within substantially the ZX plane generated by the vibrating body 2 supported by the lower support member 18 and the vibrating body 2 supported by the upper support member 19 are in opposite directions to each other. Thus, the two vibrating bodies 2 arranged to face the contact body 10 can drive the contact body 10 in the same direction. Further, the connecting flexible substrate 40 has a U-turn portion 40a formed thereon in order to move integrally with movement of the vibrating body 2 in the X direction. The U-turn portion 40a enables the connecting flexible substrate 40 to stably drive in the X direction without interfering with other components.

With the above-described configuration, if the vibration type actuator 100 drives the vibrating body 2, the vibrating body 2, the holding member 9, the lower support member 18, the upper support member 19, and the tension coil spring 25 integrally move in the axial direction of the guide bar 22 with respect to the contact body 10.

Next, a configuration of the lower support member 18 and a configuration for bringing the protrusion portions 5 of the vibrating body 2 into contact with the contact body 10 are described with reference to FIGS. 3A and 3B.

The vibrating body 2 is fixed to the holding member 9 by means of adhesion, welding, and the like near an end portion (a fixing portion extending in the longitudinal direction from a flat plate portion) of the vibrating body 2 in the longitudinal direction (direction connecting the tip ends 5a of the two protrusion portions 5).

Here, as illustrated in FIG. 3A, an upper surface of the lower support member 18 is provided with a plurality of (here, two) guide portions 18c. The guide portions 18c have a cylindrical shape and protrude in the Z direction from the upper surface of the lower support member 18. The two guide portions 18c are spaced apart in the X direction. A distance between the two guide portions 18c is larger than a distance between the two protrusion portions 5 of the vibrating body 2. The two guide portions 18c correspond to an example of a pair of guide portions.

On the other hand, as illustrated in FIG. 3B, a plurality of (here, two) guide receiving portions 9a is provided on a lower surface of the holding member 9. The guide receiving portions 9a are holes as concave portions that are cylindrically concaved from the lower surface of the holding member 9 in the Z direction. The guide receiving portions 9a may be through holes or bottomed holes. The two guide receiving portions 9a are spaced apart in the X direction. A distance between the two guide receiving portions 9a is substantially the same as the distance between the two guide portions 18c. The guide portions 18c can be inserted into the guide receiving portions 9a. The two guide receiving portions 9a correspond to an example of a pair of guide receiving portions. Further, as viewed from the Z direction, the two protrusion portions 5 of the vibrating body 2 are located between the two guide receiving portions 9a.

In a state where the guide portions 18c are inserted into the guide receiving portions 9a, the holding member 9 can slide along the axial direction of the guide portions 18c of the lower support member 18.

Here, the holding member 9 and the lower support member 18 are formed of a resin material such as polycarbonate or polyoxymethylene (POM) in order to provide a structure that does not easily transmit the vibration of the vibrating body 2. Thus, a gap between the guide receiving portion 9a provided on the holding member 9 and the guide portion 18c provided on the lower support member 18 has accuracy that allows resin molding and is larger than that made of a metallic material.

The driving force of the vibrating body 2 is transmitted to the guide portions 18c, so that a diameter of the cylindrical guide portion 18c is formed large enough not to be damaged if the driving force is applied.

The lower support member 18 is provided with a pair of vibration damping members 26 that attenuate the vibration transmitted from the vibrating body 2 to the holding member 9. The vibration damping member 26 has a hole portion 26a. By inserting a convex portion 18f of the lower support member 18 into the hole portion 26a, the vibration damping members 26 are attached in a state of sandwiching the holding member 9 therebetween from the transverse direction of the holding member 9. It is desirable that a material of the vibration damping member 26 is a soft resin material, for example, a molded rubber material such as butyl rubber or silicone rubber, which has high vibration damping performance. However, the material of the vibration damping member 26 is not limited to the above-described materials, and, for example, thermoplastic polyurethane (TPU), ultraviolet curing gel, and polymer gel can be used. Further, in order to enhance a damping effect, the vibration damping member 26 is mounted in as state of being deformed to an extent that a cylindrical portion is crushed. The vibration damping member 26 attenuates the vibration transmitted from the vibrating body 2 to the holding member 9, thereby preventing abnormal noise and a decrease in output of the vibration type actuator 100. The vibration damping member 26 is also attached to the upper support member 19 and has a similar function as that of the vibration damping member 26 of the lower support member 18.

A cushioning member 11 and a pressurizing block 13 are arranged to come into contact with the vibrating body 2.

The cushioning member 11 disperses a pressurizing force and is attached to the pressurizing block 13 by means of adhesion or the like. The cushioning member 11 may be made of, for example, felt. The cushioning member 11 comes into contact with one of two surfaces of the piezoelectric element 4 in a thickness direction that is not bonded to the elastic body 3.

The pressurizing block 13 is provided with a protrusion portion 13a on a surface opposite to the surface to which the cushioning member 11 is attached. The pressurizing block 13 is positioned with respect to the lower support member 18 by fitting the protrusion portion 13a into a hole portion 18e provided on the lower support member 18.

A pressurizing force that presses the tip end 5a of the protrusion portion 5 of the vibrating body 2 against the contact body 10 is applied by the tension coil spring 25. Specifically, the surface of the pressurizing block 13 opposite to the surface to which the cushioning member 11 is attached comes into contact with a protrusion portion 18d provided on the lower support member 18, so that a gap is formed between the holding member 9 and the lower support member 18, and the pressurizing block 13 is pressed toward the vibrating body 2. Accordingly, the pressurizing force that presses the tip end 5a of the protrusion portion 5 against the contact body 10 is applied only to the vibrating body 2.

Similar to the lower support member 18, the upper support member 19 is provided with the vibrating body 2, the holding member 9, the cushioning member 11, and the pressurizing block 13. Thus, a force of the tension coil spring 25 that draws the lower support member 18 and the upper support member 19 to each other is converted into a force that presses the vibrating body 2 against the contact body 10 via the pressurizing block 13, and the vibrating body 2 and the contact body 10 come into contact with each other with a predetermined pressurizing force.

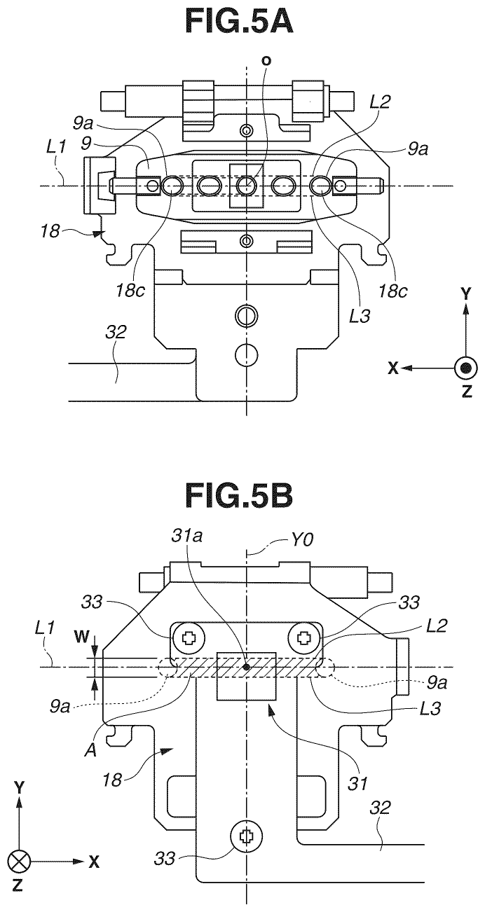

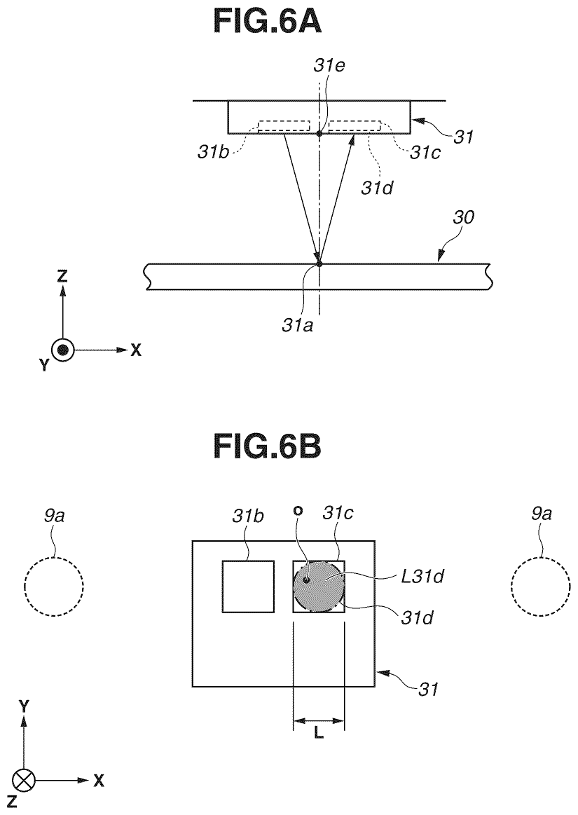

FIG. 5A is a top view of the lower support member 18, and FIG. 5B is a bottom view of the lower support member 18. FIGS. 6A and 6B illustrate a configuration of an encoder main body 31. The encoder main body 31 and the scale 30 are described below with reference to FIGS. 2, 3A, 3B, 5A, 5B, 6A, and 6B.

The encoder main body 31 (a position detection unit) detects a position of the vibrating body 2 or the contact body 10. The encoder main body 31 may detect a relative position (displacement information) of the vibrating body 2 and the contact body 10 or may detect an absolute position (position information) of the vibrating body 2 and the contact body 10. “Displacement information” refers to information detected by an incremental encoder. Further, “position information” refers to information detected by an absolute encoder.

According to the present exemplary embodiment, a reflection type optical sensor that includes a light emitting element and a light receiving element is used as the encoder main body 31. In FIG. 5B, a detection center 31a of the encoder main body 31 is indicated by a black circle. Light emitted from the encoder main body 31 is reflected by the scale 30 (detected portion) serving as a reflector, and the reflected light is received by the encoder main body 31, so that the displacement information (or the position information) is detected. The scale 30 includes information about a position that can be acquired by the encoder main body 31.

Here, the detection center 31a of the encoder main body 31 is described.

FIG. 6A illustrates a positional relationship between the encoder main body 31 and the scale 30, as viewed from the Y direction.

The encoder main body 31 includes a light emitting element 31b and a light receiving element 31c. Here, the light emitting element 31b and the light receiving element 31c are spaced apart in the X direction. The light emitting element 31b obliquely emits light toward the scale 30, and the light receiving element 31c receives the light reflected by the scale 30 through a detection window portion 31d. An incident angle of the light traveling from the light emitting element 31b to the scale 30 is equal to a reflection angle of the light reflected by the scale 30, so that a trajectory of the light forms an isosceles triangle. An apex of the isosceles triangle is the detection center 31a of the encoder main body 31 in detecting the position of the scale 30. The detection center 31a coincides with an optical center 31e that is the center between the light emitting element 31b and the light receiving element 31c of the encoder main body 31 in an XY plane. In other words, if the detection center 31a is extended in the Z direction, it overlaps with the optical center 31e. According to the present exemplary embodiment, the center between the light emitting element 31b and the light receiving element 31c (the center of the base of the isosceles triangle) is the optical center 31e, as viewed from the Z direction.

According to the present exemplary embodiment, as viewed from the Z direction, the center between the light emitting element 31b and the light receiving element 31c coincides with the detection center 31a, but the present invention is not limited to this case, and it differs depending on the optical sensor of the encoder main body 31. For example, in a case of an optical sensor that includes a plurality of light emitting elements arranged to surround a light receiving element with the light receiving element at the center, a position of the light receiving element is the optical center and the detection center as viewed from the Z direction.

The encoder main body 31 is mounted on a surface of an encoder flexible substrate 32 using solder or the like. Further, the encoder flexible substrate 32 is fixed to the lower support member 18 by a plurality of fixing screws 33, so that the encoder main body 31 is fixed to the lower support member 18 via the encoder flexible substrate 32. Thus, if the vibrating body 2 and the contact body 10 move relative to each other, the encoder main body 31 moves relative to the contact body 10 together with the vibrating body 2 and the lower support member 18. At this time, since the encoder main body 31 and the scale 30 move relative to each other, the encoder main body 31 can detect the relative position (or the absolute position) of the vibrating body 2 and the contact body 10. The encoder main body 31 and the scale 30 are arranged between the lower support member 18 and the foundation unit 21 so that the encoder main body 31 faces a pattern of the scale 30 in the Z direction as viewed from the X direction (the direction in which the contact body 10 and the vibrating body 2 move relative to each other).

The encoder flexible substrate 32 has a U-turn portion 32a formed thereon in order to realize a stable power supply during movement (see FIG. 2). The U-turn portion 32a of the encoder flexible substrate 32 is arranged so as not to overlap with the U-turn portion 40a of the connecting flexible substrate 40 in the Y direction. Therefore, the U-turn portion 32a of the encoder flexible substrate 32 and the U-turn portion 40a of the connecting flexible substrate 40 do not come into contact with each other during movement of the vibrating body 2 in the X direction, and thus it is possible to prevent connection failure, disconnection, and the like due to wear of the flexible substrates. Further, since a distance between a sensor signal and a power supply signal to the vibrating body 2 can be separated, noise can be suppressed, and the sensor signal can be stably read. However, the U-turn portion 32a of the encoder flexible substrate 32 and the U-turn portion 40a of the connecting flexible substrate 40 are not limited to the case where they do not overlap with each other in the Y direction and may be arranged to overlap with each other in the Y direction, for example, for miniaturization.

The encoder main body 31 according to the present exemplary embodiment is arranged at a position at which the relative position or the absolute position of the vibrating body 2 and the contact body 10 can be detected with high accuracy. Specifically, the encoder main body 31 is fixed to the lower support member 18 (support unit) at a position overlapping with an area A sandwiched between the pair of guide receiving portions 9a as viewed from the Z direction.

Here, the area A sandwiched between the pair of guide receiving portions 9a is described.

FIG. 5B is the bottom view of the lower support member 18, and the pair of guide receiving portions 9a provided on the holding member 9 are illustrated in hidden lines (dashed lines). In FIG. 5B, a straight line that is substantially the center of the two guide receiving portions 9a in the X direction is indicated by Y0, and a straight line connecting the centers of the circles of the two guide receiving portions 9a is indicated by L1. Further, straight lines connecting end portions of outlines of the circles of the two guide receiving portions 9a that are separated from the straight line L1 in the Y direction are indicated by L2 and L3. In other words, the straight line L1 passes through substantially the center of a width W of the guide receiving portions 9a in the Y direction. Here, the area A sandwiched between the pair of guide receiving portions 9a is a hatched area between the pair of guide receiving portions 9a and surrounded by the straight lines L2 and L3. In other words, the area A corresponds to an area that is sandwiched between the pair of guide receiving portions 9a in the X direction and overlaps with projected areas of the pair of guide receiving portions 9a along the Y direction.

In this way, the encoder main body 31 is fixed to the lower support member 18 (support unit) at a position overlapping with the area A.

The detection center 31a of the encoder main body 31 is located within the area A as viewed from the Z direction.

Specifically, the detection center 31a is located substantially at the center of the width W of the guide receiving portions 9a in the Y direction and is on the straight line L1. In other words, the encoder main body 31 has the detection center 31a at substantially the center of the pair of guide receiving portions 9a as viewed from the Z direction.

Further, the detection center 31a is substantially the center between one guide receiving portion 9a and the other guide receiving portion 9a and is on the straight line Y0. In other words, the encoder main body 31 has the detection center 31a at substantially the center of the width of the guide receiving portions 9a in the Y direction as viewed from the Z direction.

As illustrated in FIG. 6B, the light receiving element 31c of the encoder main body 31 overlaps with the center O between the pair of guide receiving portions 9a as viewed from the Z direction. In other words, the center of the pair of guide receiving portions 9a is an area centroid O of the projected areas of the pair of guide receiving portions 9a projected onto the XY plane.

FIG. 6B is a bottom view of the encoder main body 31 as viewed from below. Here, the pair of guide receiving portions 9a provided on the holding member 9 are indicated by hidden lines (dashed lines), and the center of the pair of guide receiving portions 9a is indicated by O. The light receiving element 31c includes the detection window portion 31d with a predetermined opening diameter at a position where it can receive at least a regular reflection component of scattering light emitted from the light emitting element 31b and scattering backward by the scale 30. The detection window portion 31d has the opening diameter corresponding to a lens diameter of an objective lens L31d indicated by an alternate long and short dash line circle. The detection window portion 31d of the light receiving element 31c overlaps with the center O between the pair of guide receiving portions 9a as viewed from the Z direction. In this way, the encoder main body 31 includes the detection window portion 31d at a position overlapping with the center of the pair of guide receiving portions 9a as viewed from the Z direction. By providing the detection window at a position that satisfies this positional relationship, it is possible to reduce positional variation of the detection unit that tilts during driving due to influence of a gap between the pair of guide receiving portions 9a and a pair of guide portions 9b (not shown in FIG. 6B) and stress in a yaw direction that the support unit receives during driving. In other words, it is desirable that the center O of the pair of guide receiving portions 9a is located within a size L (range) in the X direction of the detection window portion 31d of the light receiving element 31c. The stress in the yaw direction corresponds to stress that the support unit (lower support member 18) receives around an axis (Z direction) along a second direction with respect to a first direction (X direction). The stress in the yaw direction is stress along a circumferential direction of the XY plane in FIG. 6B. The stress in the yaw direction may be paraphrased as torque in the yaw direction.

Next, an action that enables the encoder main body 31 arranged as described above to detect the relative position or the absolute position of the vibrating body 2 and the contact body 10 with high accuracy is described.

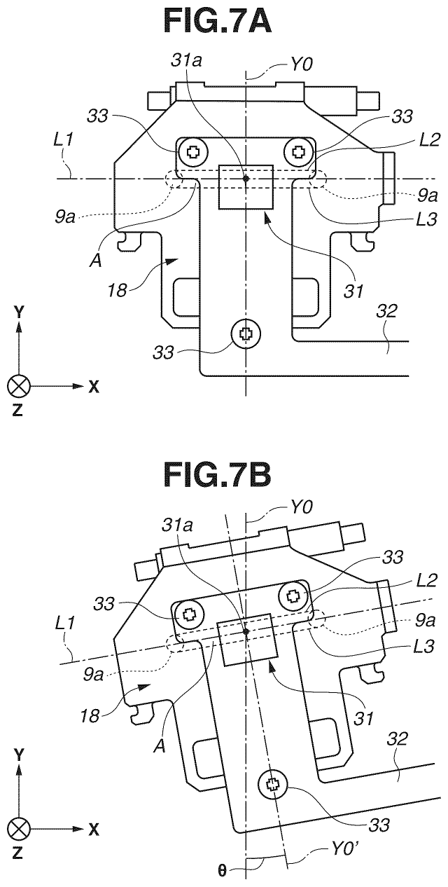

FIGS. 7A and 7B are bottom views of the lower support member 18 according to the present exemplary embodiment. In FIGS. 7A and 7B, the encoder main body 31 is located within the area A as described above. FIG. 7A illustrates a state where the lower support member 18 is not rotated, and FIG. 7B illustrates a state where the lower support member 18 is rotated by θ around a Z axis.

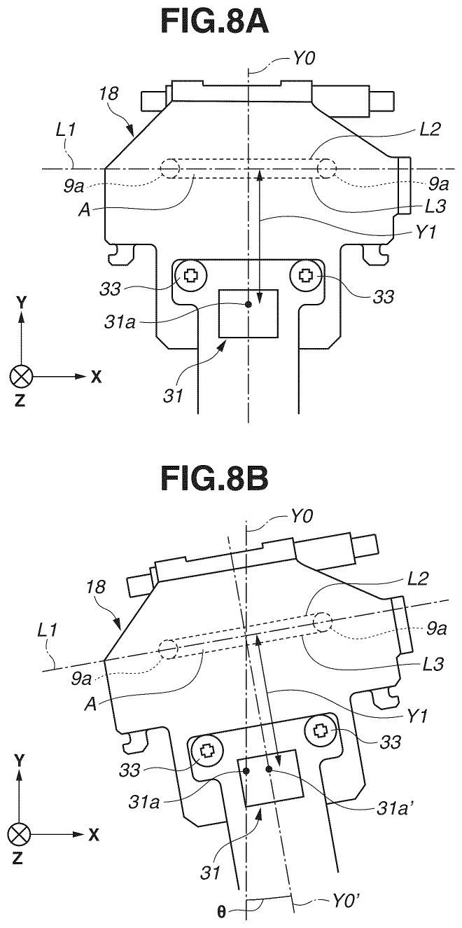

FIGS. 8A and 8B are bottom views of the lower support member 18 according to a comparative example. In FIGS. 8A and 8B, the encoder main body 31 does not overlap with the above-described area A, and the position of the detection center 31a is a distance Y1 away from the straight line L1 in the Y direction. FIG. 8A illustrates a state where the lower support member 18 is not rotated, and FIG. 8B illustrates a state where the lower support member 18 is rotated by θ around the Z axis.

In FIGS. 7B and 8B, rotation angles are enlarged to facilitate understanding.

In the vibration type actuator 100, the vibrating body 2 is held by the holding member 9 as described above. Meanwhile, a gap is provided between the guide receiving portion 9a of the holding member 9 and the guide portion 18c of the lower support member 18 so that the holding member 9 can slide in the axial direction of the guide portion 18c of the lower support member 18. In other words, a diameter of the circle of the guide receiving portion 9a is larger than a diameter of the circle of the guide portion 18c. Further, a gap is provided between the through hole portion 19c and the guide bar 22 so that the through hole portion 19c of the upper support member 19 connected to the lower support member 18 can slide on the guide bar 22.

In the above-described configuration, if an external force from a driven object acts on the drive transmission unit 19d of the vibration type actuator 100, the position of the vibrating body 2 is maintained by a frictional force with the contact body 10.

On the other hand, as illustrated in FIG. 8B, the lower support member 18 rotates around the Z axis with an intersection point of the straight lines L1 and Y0 as a center by an amount corresponding to the gap between the guide receiving portion 9a of the holding member 9 and the guide portion 18c. If a rotation angle at this time is θ, the detection center 31a moves by an amount of Y1*sin θ in the X direction to a position of a detection center 31a′. Thus, the detection center 31a of the encoder main body 31 moves in the X direction by the amount of Y1*sin θ with respect to the scale 30 fixed to the foundation unit 21. Accordingly, even though a relative movement does not occur between the vibrating body 2 and the contact body 10, the encoder main body 31 generates a signal indicating a movement of the amount of Y1*sin θ, and thus positioning accuracy of the vibration type actuator 100 is reduced, which makes control unstable.

On the other hand, the encoder main body 31 according to the present exemplary embodiment is fixed to the lower support member 18 (support unit) at the position overlapping with the area A sandwiched between the pair of guide receiving portions 9a. Specifically, the detection center 31a of the encoder main body 31 is located on the straight line L1 and also on the straight line Y0. Thus, as illustrated in FIG. 7B, even if an external force acts on the vibration type actuator 100 and the lower support member 18 rotates around the Z axis, the detection center 31a only rotates at the intersection point of the straight lines L1 and Y0 and does not move in the X direction. Therefore, the detection center 31a of the encoder main body 31 does not move in the X direction with respect to the scale 30 fixed to the foundation unit 21, and a signal indicating a movement is not generated.

In this way, the encoder main body 31 is fixed to the lower support member 18 (support unit) at the position overlapping with the area A sandwiched between the pair of guide receiving portions 9a. Thus, even if the encoder main body 31 is moved by the influence of the gap between the guide portion 18c and the guide receiving portion 9a, a movement amount is limited. Particularly, the detection center 31a of the encoder main body 31 is located at the intersection point of the straight lines L1 and Y0, and thus the encoder main body 31 can detect the relative movement (or the absolute position) of the vibrating body 2 and the contact body 10 with high accuracy. In this way, the encoder main body 31 can detect the relative position of the vibrating body 2 and the contact body 10 with high accuracy, so that the positioning accuracy of the vibration type actuator 100 is improved, and the stable control can be achieved.

As described above, according to the present exemplary embodiment, even if the lower support member 18 has a structure having a backlash, such as a gap, with respect to the holding member 9, the positioning accuracy of the vibration type actuator 100 is improved, and thus the vibration type actuator 100 can be driven with high accuracy.

According to the present exemplary embodiment, a case is described in which the detection center 31a is located on the straight line L1, but the present invention is not limited to this case. For example, the detection center 31a may be located between the straight lines L2 and L3. In this case, the detection center 31a moves in the X direction in association with the rotation of the lower support member 18 around the Z axis, but the movement amount is very small, so that the vibration type actuator 100 can be driven with higher accuracy than that according to the comparative example.

Further, according to the present exemplary embodiment, a case is described in which the detection center 31a is located on the straight line Y0, but the present invention is not limited to this case. For example, the detection center 31a may be located between the two guide receiving portions 9a. In this case, the influence of the rotation of the lower support member 18 around the Z axis is small, so that the vibration type actuator 100 can be driven with higher accuracy than that according to the comparative example.

Further, according to the present exemplary embodiment, a case is described in which the encoder main body 31 is fixed to the lower support member 18 (support unit) at the position overlapping with the area A sandwiched between the pair of guide receiving portions 9a as viewed from the Z direction, but the present invention is not limited to this case. For example, the encoder main body 31 may be located to overlap with an area sandwiched between the pair of guide portions 18c as viewed from the Z direction.

Further, according to the present exemplary embodiment, a case is described in which the detection center 31a of the encoder main body 31 is located within the area A as viewed from the Z direction, but it may be located within the area sandwiched between the pair of guide portions 18c.

Further, according to the present exemplary embodiment, a case is described in which the holding member 9 is provided with the guide receiving portions 9a and the lower support member 18 is provided with the guide portions 18c, but the present invention is not limited to this case. For example, the holding member 9 may be provided with the guide portions 18c, and the lower support member 18 may be provided with the guide receiving portions 9a.

Further, according to the present exemplary embodiment, a case is described in which the position detection unit is a reflection type optical encoder, but the present invention is not limited to this case, and the position detection unit may be one that can acquire information about a position in at least one of optical, magnetic, and electrical form. For example, the position detection unit may be of a form that adopts a magnetic sensor such as a Hall element and a magnetoresistive element as an encoder and uses a magnetic field line generation unit, specifically a magnet with a pattern, as a scale. In either form, the position detection unit can be fixed at a position overlapping with the area A sandwiched between the pair of guide receiving portions 9a as viewed from the Z direction. Further, in either form, the detection center in detecting a position by the position detection unit can be located within the area A as viewed from the Z direction. Furthermore, in either form, the detection window portion that overlaps with the center between the pair of guide receiving portions 9a can be provided as viewed from the Z direction.

### Second Exemplary Embodiment

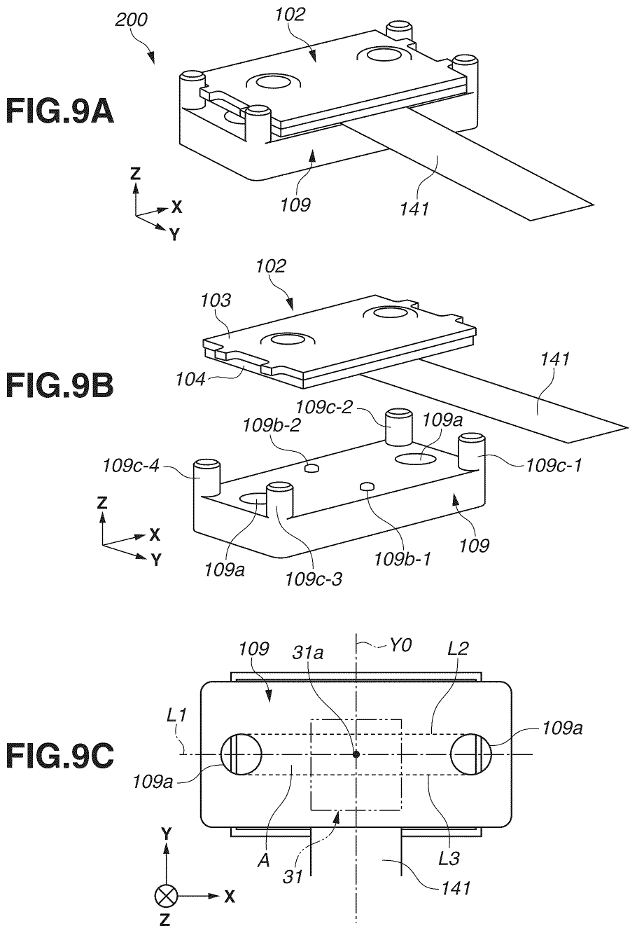

FIGS. 9A, 9B, and 9C illustrate a configuration of a vibration type actuator according to a second exemplary embodiment.

The present exemplary embodiment is different from the first exemplary embodiment in structures of a vibrating body 102 and a holding member 109. Descriptions of configurations similar to those according to the first exemplary embodiment are appropriately omitted.

The holding member 109 of a vibration type actuator 200 illustrated in FIGS. 9A, 9B, and 9C is provided with two convex portions 109b-1 and 109b-2. The two convex portions 109b-1 and 109b-2 are provided at positions near a common node of the two vibration modes of the vibrating body illustrated in FIGS. 4A and 4B to come into contact with and support the vibrating body 102 via a power supply flexible substrate 141. Thus, it is possible to support the vibrating body 102 without hindering two vibrations (displacements) generated in the vibrating body 102. According to the present exemplary embodiment, the power supply flexible substrate 141 is in contact with the convex portions 109b-1 and 109b-2 in the vibrating body 102, but a pressurizing force and a friction coefficient are adjusted so that the maximum static frictional force between the power supply flexible substrate 141 and the convex portions 109b-1 and 109b-2 is always a value greater than a thrust force generated in a contact body 110. In other words, since the convex portions 109b-1 and 109b-2 apply pressure to the vibrating body 102 as if they are in point contact, the vibrating body 102 is suppressed from moving with respect to the holding member 109 during driving of the vibration type actuator 200.

Meanwhile, the holding member 109 is provided with four loose-fitting portions 109c (109c-1, 109c-2, 109c-3, and 109c-4). The loose-fitting portions 109c support (loosely fit) with respect to an outer circumferential surface of the vibrating body 102 with backlash. The loose-fitting portions 109c function as a stopper in positioning the vibrating body 102 during assembly or in a case where some external force acts on the contact body 110.

The loose-fitting portions 109c may be in contact with the outer circumferential surface of the vibrating body 102 at two points different from vibration nodes. However, as described above, the maximum frictional force between the power supply flexible substrate 141 and the convex portions 109b-1 and 109b-2 is greater than the thrust force generated in the contact body 110, so that no force in the X direction and the Y direction acts on a contact portion between the loose-fitting portion 109c and the vibrating body 102. Thus, a loss due to contact between the loose-fitting portion 109c and the vibrating body 102 is negligible and does not cause a problem in driving.

As described above, there is direct contact between the convex portion 109b of the holding member 109 and the vicinity of the node of the vibrating body 102, and between the loose-fitting portion 109c and the outer circumferential surface of the vibrating body 102, so that it is desirable that a material of the holding member 109 is a resin material with a high vibration insulating property in order to prevent generation of abnormal noise. The convex portion 109b desirably has a high friction coefficient in order to increase a holding force with the vibrating body 102, and the loose-fitting portion 109c desirably has a low friction coefficient in order to reduce friction loss with the vibrating body 102. Thus, it is possible to separately apply a coating to the convex portion 109b to increase the friction coefficient and a coating to the loose-fitting portion 109c to decrease the friction coefficient. Further, separate components with friction coefficients respectively suitable for the convex portion 109b and the loose-fitting portion 109c may be bonded or press fitted thereto.

The vibration type actuator 200 according to the present exemplary embodiment positions the vibrating body 102 using the loose-fitting portion 109c of the holding member 109, and holds the vibrating body 102 using the frictional force between the convex portion 109b and the vibrating body 102. Thus, a connection portion between the vibrating body and the holding unit as in the first exemplary embodiment is unnecessary. Therefore, a size of the vibrating body 102 in the X direction, which is a driving direction, can be reduced. Further, since the vibrating body 102 is not fixed to the holding member 109 by adhesion or the like, there is no suppression of vibration by adhesion, so that a speed, an efficiency, a thrust force, and the like of the vibration type actuator 200 can be improved.

The holding member 109 according to the present exemplary embodiment is provided with two guide receiving portions 109a. The guide receiving portions 109a are through holes, which are cylindrically concaved in the Z direction. On the other hand, the lower support member 18, which is not illustrated, has the same configuration as that according to the first exemplary embodiment and is provided with two guide portions 18c, which are not illustrated. The guide portions 18c can be inserted into the guide receiving portions 109a.

In a state where the guide portions 18c are inserted into the guide receiving portions 109a, the holding member 109 can slide along the axial direction of the guide portions 18c of the lower support member 18. As the vibrating body 102 moves in the X direction, the holding member 109 and the lower support member 18 move integrally.

Gaps between the two guide receiving portions 109a provided on the holding member 109 and the guide portions 18c provided on the lower support member 18 have accuracy that allows resin molding and are larger than that made of a metallic material.

According to the present exemplary embodiment, as in the first exemplary embodiment, the encoder main body 31 is fixed to the lower support member 18 (support unit) at a position overlapping with the area A sandwiched between the pair of guide receiving portions 109a as viewed from the Z direction. In FIG. 9C, the encoder main body 31 fixed to the lower support member 18 is indicated by an imaginary line (alternate long and two short dashes line), and the detection center 31a of the encoder main body 31 is indicated by a black circle. A straight line that is the center of the two guide receiving portions 109a is indicated by Y0, and a straight line connecting the centers of the circles of the two guide receiving portions 109a is indicated by L1. Further, straight lines connecting end portions of outlines of the circles of the two guide receiving portions 109a that are separated in the Y direction from the straight line L1 are indicated by L2 and L3. According to the present exemplary embodiment, as in the first exemplary embodiment, the detection center 31a of the encoder main body 31 is located at the intersection point of the straight lines L1 and Y0.

In this way, the encoder main body 31 is fixed to the lower support member 18 (support unit) at the position overlapping with the area A sandwiched between the pair of guide receiving portions 109a. Thus, even if the encoder main body 31 moves due to the influence of the gap between the guide portions 18c and the guide receiving portions 109a, the movement amount is limited. Therefore, the encoder main body 31 can accurately detect the relative position of the vibrating body 102 and the contact body 10, so that the positioning accuracy of the vibration type actuator 200 is improved, and the stable control can be achieved.

### Third Exemplary Embodiment

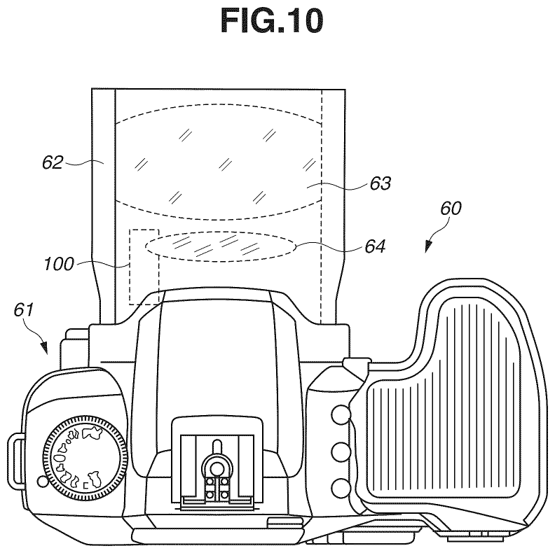

FIG. 10 is a top view illustrating a schematic configuration of an image capturing apparatus 60 provided with the vibration type actuator 100.

The image capturing apparatus 60 includes an image capturing apparatus main body 61 and a lens barrel 62.

The image capturing apparatus main body 61 includes an imaging element (not illustrated) that forms an image of light that has passed through a plurality of lens groups 63, which is described below, in the lens barrel 62.

The lens barrel 62 is detachable from the image capturing apparatus main body 61. The lens barrel 62 includes the plurality of lens groups 63 (lens), a focus adjustment lens 64 (lens), and the vibration type actuator 100. The focus adjustment lens 64 is held by a lens holding frame, which is not illustrated. The lens holding frame is connected to the upper support member 19 that is a moving body in the vibration type actuator 100. Thus, if the vibration type actuator 100 is driven, the focus adjustment lens 64 is moved in an optical axis direction and can focus on a subject.

In a case where a zoom lens is arranged in the lens barrel 62, the vibration type actuator 100 can be used as a driving source that moves the zoom lens in the optical axis direction.

Further, in a case where an image blur correction lens is arranged in the lens barrel 62, the vibration type actuator 100 can be used as a driving source that drives the image blur correction lens in a plane orthogonal to the optical axis. Furthermore, the image capturing apparatus 60 can use the vibration type actuator 200 instead of the vibration type actuator 100.

### Fourth Exemplary Embodiment

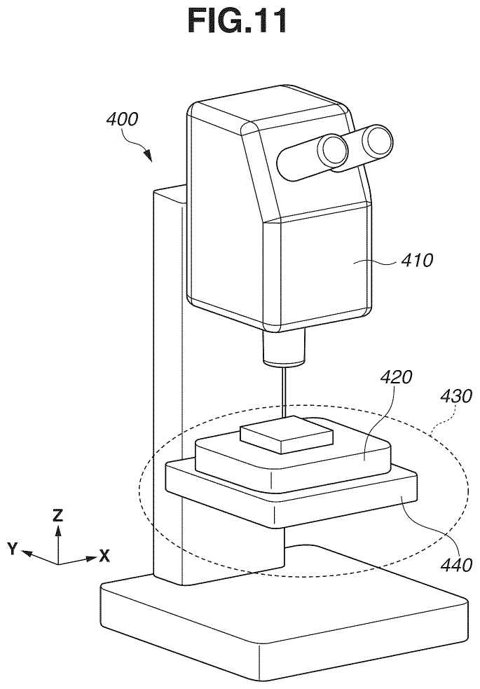

FIG. 11 is a perspective view illustrating a schematic configuration of a microscope 400 (stage apparatus) provided with the vibration type actuator 100.

The microscope 400 includes at least two or more vibration type actuators 100. A configuration of the microscope 400 provided with an X-Y stage is described as an example of the apparatus with reference to FIG. 11.

The microscope 400 includes an image capturing unit 410 that incorporates an imaging element and an optical system, which are not illustrated, and an automatic stage 430.

The automatic stage 430 includes a base 440, a first vibration type actuator (not illustrated) and a second vibration type actuator (not illustrated) that are provided on the base 440, and a stage 420 that is provided on the base 440 and moves in an X-Y plane. The above-described vibration type actuator 100 can be used for each of the first vibration type actuator and the second vibration type actuator.

The first vibration type actuator is used as a driving apparatus that drives the stage 420 in the X direction thereof. Further, the first vibration type actuator is arranged so that a direction of the relative movement of the vibrating body 2 and a part of the contact body 10 coincides with the X direction of the stage 420.

The second vibration type actuator is used as a driving apparatus that drives the stage 420 in the Y direction thereof. Further, the second vibration type actuator is arranged so that the direction of the relative movement of the vibrating body 2 and a part of the contact body 10 coincides with the Y direction of the stage 420.

An observation object is placed on an upper surface of the stage 420, and a magnified image is captured by the image capturing unit 410. If an observation range is wide, an image capturing area is changed by using the first vibration type actuator and the second vibration type actuator to drive the automatic stage 430 to move the stage 420 in an in-plane direction to move the observation object. Images captured in different image capturing areas are combined by image processing in a computer, which is not illustrated, and thus a single high-definition image with a wide observation range and can be acquired.

The microscope 400 can use the vibration type actuator 200 instead of the vibration type actuator 100.

The present invention is described in detail above based on the exemplary embodiments, but the present invention is not limited to these specific exemplary embodiments, and various forms not departing from the scope of the present invention are also included in the present invention. Further, each of the above-described exemplary embodiments is a merely example of the present invention, and each of the exemplary embodiments can be appropriately combined.

The disclosure according to the present exemplary embodiment includes following configurations.

### Configuration 1

A vibration type actuator including:
a vibrating body that includes an electrical-mechanical energy conversion element and a protrusion portion, and
a contact body with which the protrusion portion is in contact and that is provided to be movable relative to the vibrating body in a first direction,
the vibration type actuator includes:
a holding unit configured to apply pressure to the vibrating body toward the contact body in a second direction that intersects with the first direction and to hold the vibrating body to be able to vibrate;
a support unit configured to support the vibrating body via the holding unit; and a position detection unit that is fixed to the support unit and configured to detect a position of the vibrating body or the contact body,
wherein either one of the holding unit and the support unit includes a pair of guide portions that guide a relative position of the holding unit and the support unit in the second direction,
wherein the other one of the holding unit and the support unit includes a pair of guide receiving portions that are guided by the pair of guide portions, and
wherein the position detection unit is fixed to the support unit at a position overlapping with an area sandwiched between the pair of guide receiving portions as viewed from the second direction.

### Configuration 2

The vibration type actuator according to the configuration 1, wherein the area sandwiched between the pair of guide receiving portions corresponds to an area that is sandwiched between the pair of guide receiving portions in the first direction and overlaps with projected areas of the pair of guide receiving portions along a third direction that intersects with the first direction and the second direction.

### Configuration 3

The vibration type actuator according to the configuration 1 or 2, wherein the protrusion portion is located between the pair of guide receiving portions in the first direction as viewed from the second direction.

### Configuration 4

The vibration type actuator according to any one of the configurations 1 to 3,
wherein the position detection unit includes a detection window portion that overlaps with a center of the pair of guide receiving portions as viewed from the second direction.

### Configuration 5

The vibration type actuator according to any one of the configurations 1 to 4,
wherein the position detection unit has a detection center at substantially a center of the pair of guide receiving portions as viewed from the second direction.

### Configuration 6

The vibration type actuator according to any one of the configurations 1 to 5,
wherein the position detection unit has a detection center at substantially a center of a width of the guide receiving portion in a third direction that intersects with the first direction and the second direction as viewed from the second direction.

### Configuration 7

The vibration type actuator according to the configuration 2 or 6,
wherein the second direction is orthogonal to the first direction, and
wherein the third direction is orthogonal to each of the first direction and the second direction.

### Configuration 8

The vibration type actuator according to any one of the configurations 1 to 7,
wherein the protrusion portions are configured as a pair spaced apart in the first direction, and
wherein the pair of protrusion portions is placed between the pair of guide receiving portions in the first direction as viewed from the second direction.

### Configuration 9

The vibration type actuator according to any one of the configurations 1 to 8,
wherein the guide portion has a cylindrical shape protruding in the second direction, and
wherein the guide receiving portion is a concave portion into which the guide portion is inserted.

### Configuration 10

The vibration type actuator according to the configuration 9, wherein the guide receiving portion has a gap between the guide portion.

### Configuration 11

The vibration type actuator according to any one of the configurations 1 to 10, further includes a base to which the contact body is fixed,
wherein the base includes a detected portion to be detected by the position detection unit.

### Configuration 12

The vibration type actuator according to the configuration 11, wherein the detected portion includes information about a position acquirable by the position detection unit.

### Configuration 13

The vibration type actuator according to the configuration 12, wherein the position detection unit acquires the information about the position from the detected portion in at least one of optical, magnetic, and electrical form.

### Configuration 14

A lens barrel includes:
the vibration type actuator according to any one of the configurations 1 to 13; and
a lens configured to be driven by moving the contact body relative to the vibrating body.

### Configuration 15

An image capturing apparatus includes:
the vibration type actuator according to any one of the configurations 1 to 13; and
a lens configured to be driven by moving the contact body relative to the vibrating body.

### Configuration 16

A stage apparatus includes:
the vibration type actuator according to any one of the configurations 1 to 13; and
a stage configured to be driven by moving the contact body relative to the vibrating body.

The present invention is not limited to the above-described exemplary embodiments, and various modifications and changes can be made without departing from the spirit and the scope of the present invention. Therefore, the following claims are attached in order to publicize the scope of the present invention.

According to the present invention, it is possible to drive a vibration type actuator with high accuracy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A vibration type actuator including:
a vibrating body that includes an electrical-mechanical energy conversion element and a protrusion portion, and
a contact body with which the protrusion portion is in contact and that is provided to be movable relative to the vibrating body in a first direction,
the vibration type actuator comprising:
a holding unit configured to apply pressure to the vibrating body toward the contact body in a second direction that intersects with the first direction and to hold the vibrating body to be able to vibrate;
a support unit configured to support the vibrating body via the holding unit; and
a position detection unit that is fixed to the support unit and configured to detect a position of the vibrating body or the contact body,
wherein either one of the holding unit and the support unit includes a pair of guide portions that guide a relative position of the holding unit and the support unit in the second direction,
wherein the other one of the holding unit and the support unit includes a pair of guide receiving portions that are guided by the pair of guide portions, and
wherein the position detection unit is fixed to the support unit at a position overlapping with an area sandwiched between the pair of guide receiving portions as viewed from the second direction.

2. The vibration type actuator according to claim 1, wherein the area sandwiched between the pair of guide receiving portions corresponds to an area that is sandwiched between the pair of guide receiving portions in the first direction and overlaps with projected areas of the pair of guide receiving portions along a third direction that intersects with the first direction and the second direction.

3. The vibration type actuator according to claim 1, wherein the protrusion portion is located between the pair of guide receiving portions in the first direction as viewed from the second direction.

4. The vibration type actuator according to claim 1, wherein the position detection unit includes a detection window portion that overlaps with a center of the pair of guide receiving portions as viewed from the second direction.

5. The vibration type actuator according to claim 1, wherein the position detection unit has a detection center at substantially a center of the pair of guide receiving portions as viewed from the second direction.

6. The vibration type actuator according to claim 1, wherein the position detection unit has a detection center at substantially a center of a width of the guide receiving portion in a third direction that intersects with the first direction and the second direction as viewed from the second direction.

7. The vibration type actuator according to claim 2,
wherein the second direction is orthogonal to the first direction, and
wherein the third direction is orthogonal to each of the first direction and the second direction.

8. The vibration type actuator according to claim 1,
wherein the protrusion portions are configured as a pair spaced apart in the first direction, and
wherein the pair of protrusion portions is placed between the pair of guide receiving portions in the first direction as viewed from the second direction.

9. The vibration type actuator according to claim 1,
wherein the guide portion has a cylindrical shape protruding in the second direction, and
wherein the guide receiving portion is a concave portion into which the guide portion is inserted.

10. The vibration type actuator according to claim 9, wherein the guide receiving portion has a gap between the guide portion.

11. The vibration type actuator according to claim 1, further comprising a base to which the contact body is fixed,
wherein the base includes a detected portion to be detected by the position detection unit.

12. The vibration type actuator according to claim 11, wherein the detected portion includes information about a position acquirable by the position detection unit.

13. The vibration type actuator according to claim 12, wherein the position detection unit acquires the information about the position from the detected portion in at least one of optical, magnetic, and electrical form.

14. A lens barrel comprising:
the vibration type actuator according to claim 1; and
a lens configured to be driven by moving the contact body relative to the vibrating body.

15. An image capturing apparatus comprising:
the vibration type actuator according to claim 1; and
an imaging element configured to be driven by moving the contact body relative to the vibrating body.

16. A stage apparatus comprising:
the vibration type actuator according to claim 1; and
a stage configured to be driven by moving the contact body relative to the vibrating body.
